(19) United States
(12) Patent Application Publication
(10) Pub. No.: US 2016/0189476 A1
(43) Pub. Date: Jun. 30, 2016

(54) BLACKJACK SIDE BET

(71) Applicant: Adam MAJEWSKI, McKinney, TX (US)

(72) Inventor: Adam MAJEWSKI, McKinney, TX (US)

(73) Assignee: 10K BLACKJACK, LLC, McKinney, TX (US)

(21) Appl. No.: 14/801,699

(22) Filed: Jul. 16, 2015

Related U.S. Application Data
(60) Provisional application No. 62/025,999, filed on Jul. 17, 2014.
(60) Provisional application No. 62/104,940, filed on Jan. 19, 2015.

(51) Int. Cl. G07F 17/32; A63F 1/00

(52) U.S. Cl. CPC G07F 17/3244; A63F 1/00; G07F 17/3293; A63F 2001/003

(57) ABSTRACT

A method of conducting a side bet for a game of blackjack including the steps of conducting a blackjack game, accepting placement of a side bet by at least one player that pays out based upon the occurrence of successive blackjacks in the blackjack game, and paying out the at least one player who placed the side bet upon the occurrence of the successive blackjacks.

### CROSS-REFERENCE TO RELATED APPLICATION

This application claims the benefit of U.S. Provisional Application No. 62/025,999 filed 17 Jul. 2015 and U.S. Provisional Application No. 62/104,940 filed 19 Jan. 2015, both with the same title and in the name of the same inventor as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to blackjack side bet for a table game or game performed by a computing device.

### SUMMARY

Aspects of the subject technology include a method of conducting a side bet for a game of blackjack. The method includes conducting a blackjack game, accepting placement of a side bet by at least one player that pays out based upon the occurrence of successive blackjacks in the blackjack game, and paying out the at least one player who placed the side bet upon the occurrence of the successive blackjacks.

In some aspects, the side bet is payed out based on cards dealt to the player, the dealer, the player and the dealer, or the player or the dealer in successive hands. Preferably, a number of the successive blackjacks resulting in a payout to the player is three.

The player may or may not be required to increase an amount placed on the side bet in a next hand after a blackjack occurs in order to maintain the side bet. In some aspects, the player may have an option of continuing the side bet or accepting a payout for the side bet after a blackjack occurs.

The player also may or may not be a participant in the actual blackjack game itself. For example, a physically present player or a remote observer may only participate in the side bet. In other aspects, a physically or remotely present player may participate in both the blackjack game and the side bet.

The game and/or side bet according to aspects of the subject technology may be implemented via a physical gaming table (e.g., in a casino) or via a computing device (e.g., an app or computer game possibly in communication with a web or other server).

This brief summary has been provided so that the nature of the invention may be understood quickly. Additional steps and/or different steps than those set forth in this summary may be used. A more complete understanding of the invention may be obtained by reference to the following description in connection with the attached drawings.

### BRIEF DESCRIPTION OF THE DRAWINGS

FIG. 1 shows a table associated with aspects of the subject game.

FIG. 2 shows a variation of the table shown in FIG. 1.

### DETAILED DESCRIPTION OF THE INVENTION

U.S. Provisional Application No. 62/025,999 filed 17 Jul. 2015 and U.S. Provisional Application No. 62/104,940 filed 19 Jan. 2015, both with the same title and in the name of the same inventor as this non-provisional application, are hereby incorporated by reference as if fully set forth herein.

The subject invention comprises a variation of blackjack that may be implemented as a table game or as a game performed by a computing device. In a specific example, “10 K BLACKJACK” is a new format of the traditional game of blackjack.

Side Bets/Props/New deviations of blackjack are created as to create more excitement for the player, additional revenue opportunities for the casino, and to keep the player engaged and playing for longer periods of time. 10 K BLACKJACK is a new game/side bet which allows the user to win $10,000 (or another predetermined amount) when the player or dealer is dealt 3 (or some other number) of successive (i.e., consecutive or in a row) blackjacks.

In blackjack, a player wins when their total card count is greater then the dealer's cards without going over 21. A natural blackjack is when a player or dealer receives an ace and one additional card with a value of 10. The side bet described herein preferably is based on successive natural blackjacks being dealt

In more detail, aspects of the subject technology include a method of conducting a side bet for a game of blackjack. The method includes conducting a blackjack game, accepting placement of a side bet by at least one player that pays out based upon the occurrence of successive blackjacks in the blackjack game, and paying out the at least one player who placed the side bet upon the occurrence of the successive blackjacks.

In some aspects, the side bet is payed out based on cards dealt to the player, the dealer, the player and the dealer, or the player or the dealer in successive hands. Preferably, a number of the successive blackjacks resulting in a payout to the player is three.

The player may or may not be required to increase an amount placed on the side bet in a next hand after a blackjack occurs in order to maintain the side bet. In some aspects, the player may have an option of continuing the side bet or accepting a payout for the side bet after a blackjack occurs.

The player also may or may not be a participant in the actual blackjack game itself. For example, a physically present player or a remote observer may only participate in the side bet. In other aspects, a physically or remotely present player may participate in both the blackjack game and the side bet.

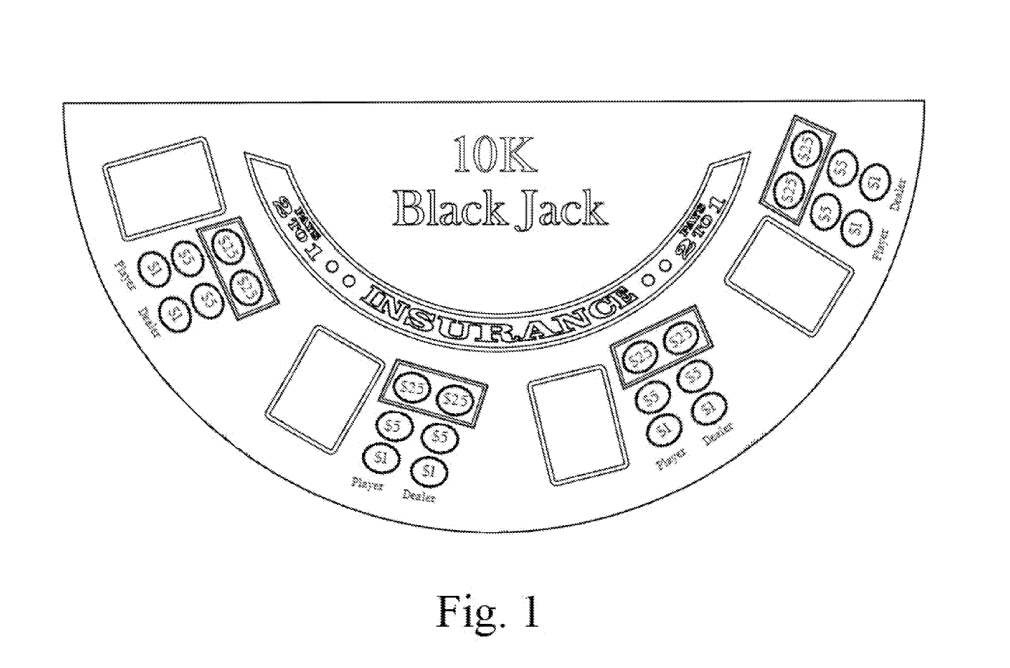

One possible implementation of the side bet is described below with reference to FIG. 1.

Prior to a blackjack hand being dealt, a player may place his traditional bet before a hand of blackjack is dealt. In addition the player may put $1 down in the $1 circle. They can place it in the circle called player, dealer, or both. By placing the $1 bet this activates the $10,000 jackpot (or predetermined jackpot). If a player places the bet on the player or dealer and no blackjack is dealt to the corresponding person they lose the $1 bet(s). If the player or dealer is dealt a natural blackjack they win stage 1 and can move to stage 2 in the jackpot.

By receiving a natural blackjack at the $1 level the player is now able to compete in the $5 level (circle). The player must place his traditional bet (amount varies from each casino). In addition they are required to put $5 down in the $5 circle for the corresponding player or dealer circle. They can only put the $5 in the circle if the corresponding person received a natural blackjack on the previous hand. If a player places the bet on the player or dealer and no blackjack is dealt to the corresponding person they lose the $5 bet(s). If the player or dealer is dealt a natural blackjack they win stage 2 and can move to the jackpot stage.

By receiving a natural blackjack at the $5 level the player is now able to compete in the $25 jackpot level (circle). The player must place his traditional bet (amount varies from each casino). In addition they are required to put $25 down in the $25 circle for the corresponding player or dealer circle. They can only put the $25 in the circle if the corresponding person received a natural blackjack on the previous hand. If a player places the bet on the player or dealer and no blackjack is dealt to the corresponding person they lose the $25 bet(s). If the player or dealer is dealt a natural blackjack corresponding to their bet they win the $10,000 or the amount predetermined by the casino.

10 K BLACKJACK can exist as a stand-alone game which requires the player to place a bet on the corresponding circles ($1, $5, and $25) or as a side bet. If 10 K BLACKJACK exists as a side bet, the jackpot $1, $5, and $25 bets preferably are not required and the player can play traditional blackjack with no additional bet required.

A player preferably cannot place a bet on the $5 or $25 circle without first having placed the $1 bet and received either 1 or 2 blackjacks successively. In additional a player cannot place a bet after the hand has been dealt.

In preferred aspects, a player cannot skip the $5 or $25 bets for any reason except for opting out to continue (i.e., a player is not forced to bet more money, but they lose the chance to advance or move forward if they opt out). If he or she wins the $1 level which would qualify him or her to advance to stage 2, he or she must play the next hand dealt. If he or she skips a hand, he or she preferably will have to start back over at the $1 level.

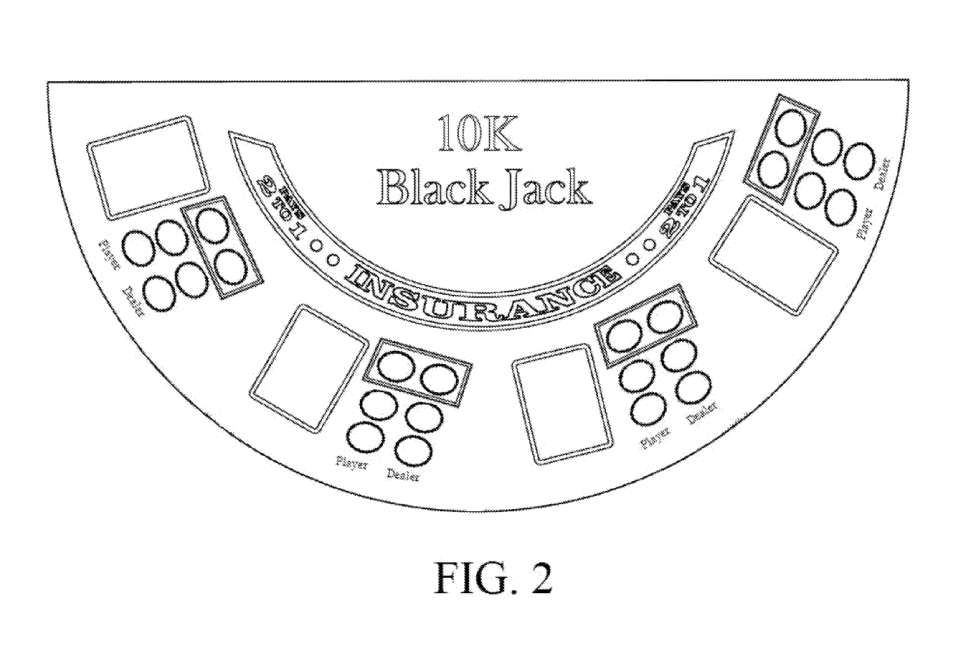

The specific amounts of the bets and associated rules as shown and described above are preferred. In preferred embodiments, the ratio of $1/$5/$25 to win $10,000 is maintained. However, other bet structures for the side bet may be used. Thus, FIG. 2 shows a variation of the table shown in FIG. 1 with the $1/$5/$25 betting amounts removed. Some possible alternatives are set forth below:

(1) Bet amounts are $1/$2/$3 for either player/dealer or both to get a blackjack. The bet is taken by the house if a blackjack is not dealt, and the player has to start over if they want to make the side bet again. If a blackjack is dealt, the player has to bet the amount for the next level if they want to continue the side bet. Payouts of ˜$20, $400, and $10 k may be made at the various levels, but this may vary based on casino preference and/or legal requirements.

(2) Bet amounts are $1/$2/$3 for either player/dealer or both to get a blackjack. The bet is taken by the house if a blackjack is not dealt, and the player has to start over if they want to make the side bet again. If a blackjack is dealt, the player can take the payout for that level or (for the first two levels) press their bet by adding $1. Payouts of ˜$20, $400, and $10 k may be made at the various levels, but this may vary based on casino preference and/or legal requirements.

(3) Bet amounts are $1/$1/$1 for either player/dealer or both to get a blackjack. The bet is taken by the house if a blackjack is not dealt, and the player has to start over if they want to make the side bet again. If a blackjack is dealt, the player can take the payout for that level or (for the first two levels) move their $1 bet to the next level. In other words, the player gets paid or moves on to the next level without adding to the side bet. Payouts of ˜$20, $400, and $10 k may be made at the various levels, but this may vary based on casino preference and/or legal requirements.

(4) Bet amounts are $1/$1/$1 for either player/dealer or both to get a blackjack. The bet is taken by the house if a blackjack is not dealt, and the player has to start over if they want to make the side bet again. If a blackjack is dealt, the player can take the payout for that level and (for the first two levels) move their $1 bet to the next level. In other words, the player gets paid and also moves on to the next level without adding to the side bet. Payouts of ˜$10, $200, and $5 k may be made at the various levels, but this may vary based on casino preference and/or legal requirements.

(5) The successive blackjacks that qualify for advancing the side bet and/or paying out the player may be those dealt to the player, the dealer, the player and the dealer, or the player or the dealer in successive hands.

The subject technology is not limited to the foregoing variations.

The blackjack games involving side bets as described above may be implemented as a table game (e.g., in a casino). The blackjack games involving side bets as described above may also be implemented as a game performed by a computing device. In particular, the game may be performed by one or more computing devices including at least a tangible computing element. Examples of a tangible computing element include but are not limited to a microprocessor, application specific integrated circuit, programmable gate array, and the like. A tangible computing element may operate in one or more of a digital, analog, electric, photonic, and/or some other manner. Examples of a computing device include but are not limited to a mobile computing device such as a smart phone or tablet computer, a wearable computing device (e.g., Google® Glass), a laptop computer, a desktop computer, a server, a client that communicates with a server, a smart television, a game console, a computerized gaming device in a casino, a part of a cloud computing system, a virtualized computing device that ultimately runs on tangible computing elements, or any other form of computing device. The computing device preferably includes or accesses storage for instructions and data used to perform steps such as those discussed above.

Additionally, some operations may be considered to be performed by multiple computing devices. For example, steps of displaying may be considered to be performed by both a local computing device and a remote computing device that instructs the local computing device to display something. For another example, steps of acquiring or receiving may be considered to be performed by a local computing device, a remote computing device, or both. Communication between computing devices may be through one or more other computing devices and/or networks.

In a more general sense, the subject technology and/or game encompasses any set of rules permitting a player to place a bet on more than one blackjack (i.e., a 10 value card plus an ace) occurring is succession on a blackjack gaming table or computer implemented blackjack game.

The invention is in no way limited to the specifics of any particular embodiments and examples disclosed herein. For example, the invention may apply to blackjack games with different insurance rules than those depicted as well as to any other forms of blackjack games. In addition, the terms “aspect,” “preferable,” “example,” “e.g.,” “may,” and the like denote features that may or may not necessarily be essential to various implementations of the invention. Other variations are possible which remain within the content, scope and spirit of the invention, and these variations would become clear to those skilled in the art after perusal of this application.

1. A method of conducting a side bet for a game of blackjack, comprising steps of:
conducting a blackjack game;
accepting placement of a side bet by at least one player that pays out based upon the occurrence of successive blackjacks in the blackjack game; and
paying out the at least one player who placed the side bet upon the occurrence of the successive blackjacks.

2. The method as in claim 1, wherein the side bet is payed out based on cards dealt to the player in successive hands.

3. The method as in claim 1, wherein the side bet is payed out based on cards dealt to the dealer in successive hands.

4. The method as in claim 1, wherein the side bet is payed out based on cards dealt to the player, the dealer, the player and the dealer, or the player or the dealer in successive hands.

5. The method as in claim 1, wherein a number of the successive blackjacks resulting in a payout to the player is three.

6. The method as in claim 1, wherein the player is required to increase an amount placed on the side bet in a next hand after a blackjack occurs in order to maintain the side bet.

7. The method as in claim 1, wherein the player is not required to increase an amount placed on the side bet in a next hand after a blackjack occurs in order to maintain the side bet.

8. The method as in claim 1, wherein the player has an option of continuing the side bet or accepting a payout for the side bet after a blackjack occurs.

9. The method as in claim 1, wherein the player is a participant in the blackjack game.

10. The method as in claim 1, wherein the player is not a participant in the blackjack game but rather only participates in the side bet.

11. The method as in claim 10, wherein the player participates in the side bet while physically present at the blackjack game.

12. The method as in claim 10, wherein the player participates in the side bet remotely while not physically present at the blackjack game.

13. The method as in claim 1, wherein the method is performed on a gaming table.

14. The method as in claim 1, wherein the method is performed by a computing device.
